(19) United States
(12) Patent Application Publication
(10) Pub. No.: US 2016/0284002 A1
(43) Pub. Date: Sep. 29, 2016

(54) V-Police (Virtual Personal online individual comfort evaluator)

(71) Applicant: Gregory C. Mullaney, Cockevsville, MD (US)

(72) Inventor: Gregory C. Mullaney, Cockevsville, MD (US)

(21) Appl. No.: 14/665,834

(22) Filed: Mar. 23, 2015

(51) Int. Cl. G06Q 30/06

(52) U.S. Cl. CPC G06Q 30/0631

(57) ABSTRACT

A method for online individual comfort evaluation. The evaluation method comprising a means for logging into a server comprising individual comfort evaluation, a means for designating a customer; a means for identifying a customer; a means for entering into server personal physical parameters; a creating a data base accessible by said designated means containing a plurality of the personal physical parameters; a means for calculation of personal comfortably score based on the personal physical parameters; a means for selection of furniture items based on said personal comfortably score; and a means for displaying said selection of the furniture items.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present invention generally relates to an online evaluator. More specifically, the present invention is an online evaluator by which people can evaluate their personal comfort levels and buy upholstered furniture online as per their comfort levels. This invention would enable a potential online buyer of upholstered furniture to make a reasonable assumption as to its comfort level based on their individual body type, weight, height, and clothing size.

(2) Background of Invention

Online purchasing is a new way to buy, sell, trade, and barter goods and services worldwide. This novel form of buying, selling, trading, and bartering may commonly be referred to as electronic commerce or e-commerce, and for electronic business or e-business. The process of conducting these types of transactions can be called an electronic commerce transaction, electronic business transaction, e-commerce transaction, or e-business transaction.

By purchasing through e-business transactions, people can buy many different things from many different suppliers. Online customers can find various things appealing to them on the internet and buy them without wasting their time going to the store location.

However, online customers cannot buy everything online. Online purchasing of furniture and vehicles, for example, has serious limitations. Currently, web sales of residential furniture are predominantly (+/−88%) case goods, bedrooms, dining rooms, casual dining, cocktail/and tables, entertainment centers, etc. Purchasing decisions are based on appearance, color, and physical dimensions (length, width, and height). Online upholstered furniture may present the desired appearance, but they require tactile contact prior to a purchasing decision.

### BRIEF SUMMARY OF THE INVENTION

The present invention allows online customers to buy upholstered furniture based on their comfort level. First, they have to enter several details regarding their physical appearance in the evaluator such as their height, weight, and body type. After entering these details, the customers can see a list of upholstered furniture which suits their comfort levels. This invention allows to the users to check their comfort level related to their body parts such as neck comfort score %, shoulder comfort score %, and lower back comfort score %. The system then shows the most comfortable furniture based on the shopper's scores.

### BRIEF DESCRIPTION OF THE SEVERAL VIEWS OF THE DRAWINGS

FIG. 1. depicts the screen with which the choice of weight, height, and body type are entered.

FIG. 2. depicts the screen with the results that properly reflect the buyer's comfort levels.

FIG. 3, depicts the customer sitting on the sofa determined by the evaluator based on the customer's score.

### DETAILED DESCRIPTION OF THE INVENTION

All illustrations of the drawings are for the purpose of describing the evaluator. With this invention users may learn about the furniture that suit their comfort levels.

V-Police invention is online evaluator where online customers can evaluate their comfort levels as per their body structure. By using the evaluator the customers can buy furniture that suits their individual comfort preferences.

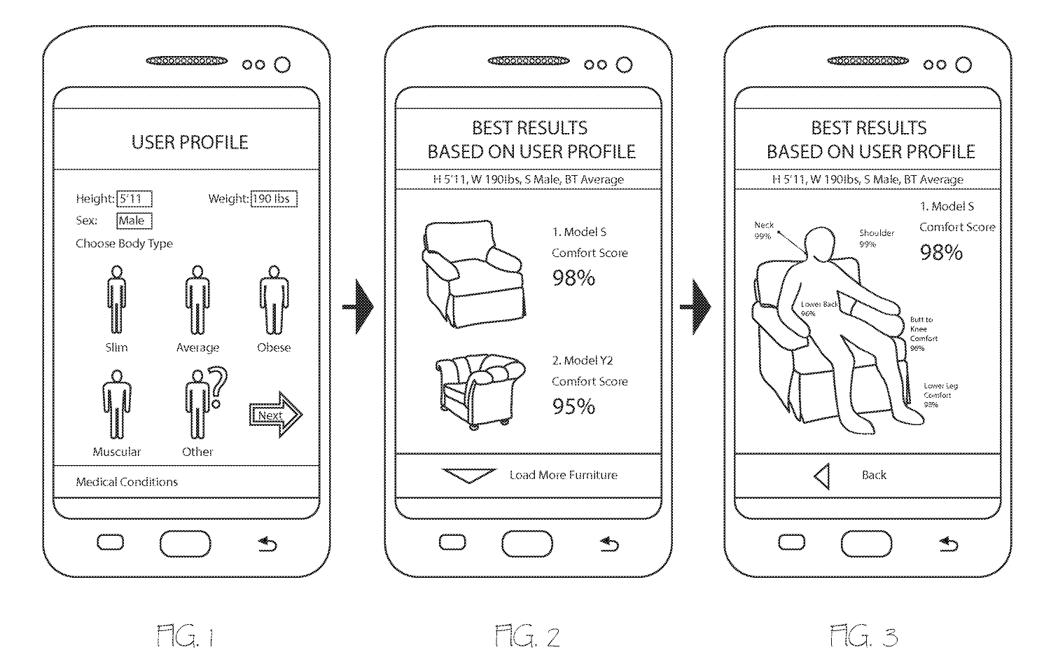

With the evaluator, as shown on FIG. 1, the users would access online database with selection of furniture including upholstery, enter their personal data for identification purposes, and enter personal physical characteristics as weight, height, and body structure as Obese, Muscular, Thin, Normal, or other parameters related to their body type. Based on the information they provide to the evaluator, the users would be provided with a list of upholstery provided by manufacturers, with their respective specifications as to the pitch (angle) of the back of each upholstered piece and the type of cushion filling and springing used, size (square inches) of the seat cushion area following which the users could learn about their comfortability score as per their body, and then make a decision as to which piece of upholstery is the best for them. As shown on FIGS. 2 and 3.

Furthermore, in according to the invention, the total firmness of the seats of the upholstery is established by estimating the total pressure exerted by the virtual person's weight. This would include the type(s) of filling used in the seat cushion, the front rail whether “fixed” (part of the framing of the product and therefore ‘hard’) or soft and flexible (typically fish mouth springing). And the frame undercarriage of the upholstery may have individual coil springs, wood platform, uni-torgue snake springs.

This invention is to be used strictly for online transaction. Because this invention allows customers to buy furniture online without going anywhere, it saves the customer's time and money. However, the major advantage of purchasing furniture online with the help of the evaluator is the buyer's satisfaction with their comfort level.

Although the invention has been explained in relation to its preferred embodiment, it is to be understood that many other possible modifications and variations can be made without departing from the spirit and scope of the invention.

I claim:

1. A method for online individual comfort evaluation comprising:
means for logging into a server comprising individual comfort evaluation;
means for designating a customer;
means for identifying a customer;
means for entering into server personal physical parameters;
creating a data base accessible by said designated means containing a plurality of the personal physical parameters;
means for calculation of personal comfortably score based on the personal physical parameters;
means for selection of furniture items based on said personal comfortably score; and
means for displaying said selection of the furniture items.

2. The method of claim 1 wherein said means for entering into server the personal physical parameters is weight and height.

3. The method of claim 1 wherein said means for entering into server the personal physical parameters is body structure.

4. The method of claim 1 wherein said means for selection of furniture items is selection of piece of upholstery.

5. The method of claim 1 wherein said means for selection of furniture items based on personal comfortably score is their comfortably score as per their body.
